(19) United States
(12) Patent Application Publication
(10) Pub. No.: US 2026/0290659 A1
(43) Pub. Date: Sep. 24, 2026

(54) SHUNT RESISTOR AND MANUFACTURING METHOD THEREOF

(71) Applicant: ROHM CO., LTD., Kyoto (JP)

(72) Inventor: Tomohiro YONEKURA, Kyoto (JP)

(73) Assignee: ROHM CO., LTD., Kyoto (JP)

(21) Appl. No.: 19/563,503

(22) Filed: Mar. 11, 2026

(30) Foreign Application Priority Data
Mar. 19, 2025 (JP) 2025-044572

(51) Int. Cl. H01C 1/14; H01C 7/18; H01C 17/28

(52) U.S. Cl. CPC H01C 1/14; H01C 7/18; H01C 17/28

(57) ABSTRACT

A shunt resistor has a pair of electrode parts and a resistor body. Each of the pair of electrode parts has a flat section to be mounted on a mounting surface, and an inclined section bonded to the resistor body such that it inclines from the flat section towards the resistor body, which is positioned at a height differing from that of the mounting surface. Each of the pair of electrode parts has a force terminal, a sense terminal, and a slit. The slit is formed between the force terminal and the sense terminal. One of the position, length, or width of the slit is adjusted such that a temperature coefficient of resistance is brought closer to 0 ppm/° C.

### CROSS REFERENCE TO RELATED APPLICATION

This application is based upon and claims the benefit of priority of the prior Japanese Patent Application No. 2025-044572, filed on Mar. 19, 2025, the entire contents of which are incorporated herein by reference.

### TECHNICAL FIELD

The present disclosure relates to a shunt resistor and a manufacturing method thereof.

### BACKGROUND ART

Shunt resistors are known as resistors used for current detection in electronic devices (Japanese Patent Application Publication No. 2017-174843). A shunt resistor includes a metal plate resistor and a pair of electrodes joined to both ends of the resistor. The resistance value of the shunt resistor is measured by making a predetermined current flow through the shunt resistor and measuring the voltage between the pair of electrodes. This method for measuring resistance is called the two-terminal method.

### BRIEF DESCRIPTION OF THE DRAWINGS

FIG. 1 is a top view illustrating an example of a structure of a shunt resistor according to each embodiment.

FIG. 2 is a side view illustrating an example of a structure of a shunt resistor according to each embodiment.

FIG. 3 is a perspective view illustrating a shunt resistor and a land for explaining a method for measuring the resistance value of the shunt resistor in each embodiment.

FIG. 4 is a partial plan view illustrating the position and size of the slit in the shunt resistor according to Embodiment 1.

FIG. 5 is a diagram showing the conditions for evaluation samples of the shunt resistor according to Embodiment 1.

FIG. 6 is a diagram showing the evaluation results of the relationship between the length of the slit and the temperature coefficient of resistance in the shunt resistor according to Embodiment 1.

FIG. 7 is a diagram showing the analysis conditions that include shunt resistor models according to Embodiments 2 to 5.

FIG. 8 is a diagram showing the simulation results of the relationship between the width of the sense terminal and the temperature coefficient of resistance in the shunt resistor according to Embodiment 2.

FIG. 9 is a diagram showing the simulation results of the relationship between the width of the slit and the temperature coefficient of resistance in the shunt resistor according to Embodiment 3.

FIG. 10 is a diagram illustrating a model of the shunt resistor according to Embodiments 4 and 5.

FIG. 11 is a diagram showing the simulation results of the relationship between the width of the sense terminal and the temperature coefficient of resistance in the shunt resistor according to Embodiment 4.

FIG. 12 is a diagram showing the simulation results of the relationship between the width of the slit and the temperature coefficient of resistance in the shunt resistor according to Embodiment 5.

FIG. 13 is a perspective view illustrating the advantages of the shunt resistor according to Embodiments 4 and 5.

FIG. 14 is a cross-sectional view showing an example of a power module to which the shunt resistor according to each embodiment is applied.

### DETAILED DESCRIPTION OF EMBODIMENTS

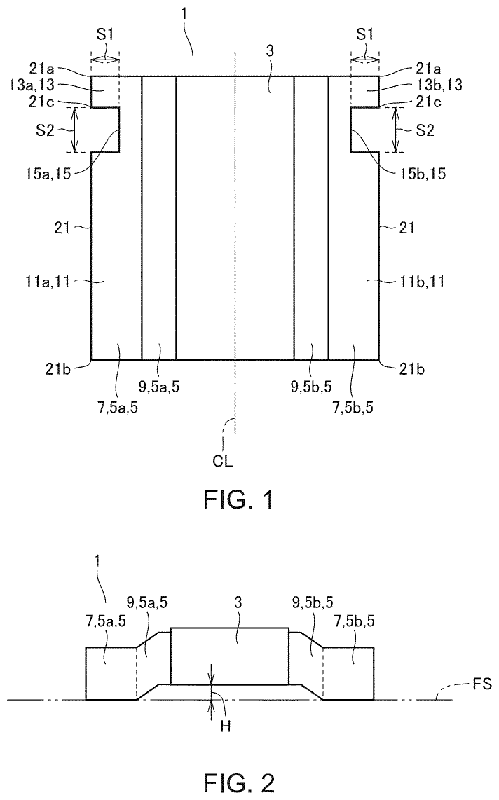

First, an overview of the shunt resistor according to each embodiment will be described. As shown in FIGS. 1 and 2, the shunt resistor 1 includes a pair of electrode parts 5 including a first electrode part 5a and a second electrode part 5b, and a resistor body 3. The resistor body 3 is disposed between the first electrode part 5a and the second electrode part 5b. The resistor body 3 is joined to each of the first electrode part 5a and the second electrode part 5b. The resistor body 3 is positioned at a height differing from that of a mounting surface FS on which the pair of electrode parts 5 is to be mounted. The resistor body 3 is made of an alloy, for example. The electrode parts 5 are made of a pure copper plate, for example.

Each of the first electrode part 5a and the second electrode part 5b includes a flat section 7 that is to be mounted on the mounting surface FS, and an inclined section 9. The inclined section 9 is joined to the resistor body 3 such that it inclines from the flat section 7 towards the resistor body 3, which is positioned at a height (height H) differing from the mounting surface FS. Each of the first electrode part 5a and the second electrode part 5b has a force terminal 11, a sense terminal 13, and a slit 15.

The first electrode part 5a has a first force terminal 11a, a first sense terminal 13a, and a first slit 15a. The first slit 15a is formed between the first force terminal 11a and the first sense terminal 13a. The second electrode part 5b has a second force terminal 11b, a second sense terminal 13b, and a second slit 15b. The second slit 15b is formed between the second force terminal 11b and the second sense terminal 13b.

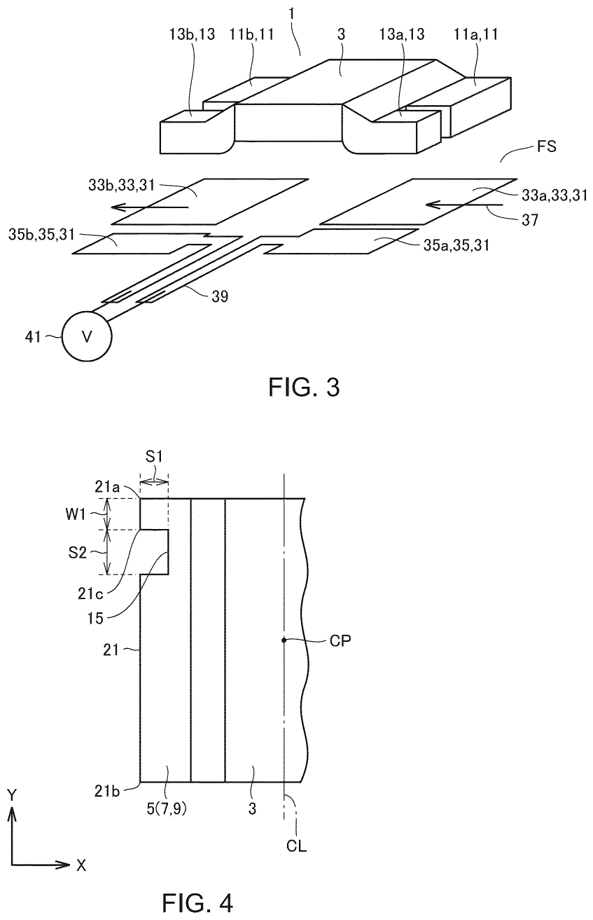

The shunt resistor 1 according to each embodiment has four terminals as the electrode parts 5 thereof: the first force terminal 11a, the first sense terminal 13a, the second force terminal 11b, and the second sense terminal 13b. As shown in FIG. 3, the shunt resistor 1, which has four terminals, is connected to the land 31 formed on the mounting surface FS. The land 31 includes a force land 33 corresponding to the force terminal 11 and a sense land 35 corresponding to the sense terminal 13.

The force land 33 has a first force land 33a and a second force land 33b. The first force land 33a and the second force land 33b are formed with a space therebetween along a force line 37, which functions as a circuit. By connecting the first force terminal 11a to the first force land 33a and the second force terminal 11b to the second force land 33b, the shunt resistor 1 is connected in series with the force line 37.

The sense land 35 has a first sense land 35a and a second sense land 35b. The first sense land 35a and the second sense land 35b are electrically connected to a sense line 39 connected to a voltmeter 41. The first sense terminal 13a is connected to the first sense land 35a, and the second sense terminal 13b is connected to the second sense land 35b, allowing the potential difference between both ends of the shunt resistor 1 to be measured by the voltmeter 41. The measured potential difference is then used to calculate the current value flowing through the force line 37.

The shunt resistor 1 has a low resistance value, ranging from a few μΩ to several hundred mΩ. In the shunt resistor 1 according to each embodiment, the first sense terminal 13a and the second sense terminal 13b are also provided, in addition to the first force terminal 11a and the second force terminal 11b that are to be electrically connected to the sense line 39.

The voltmeter 41, which is electrically connected to the first sense terminal 13a and the second sense terminal 13b, measures the potential difference between the two terminals of the shunt resistor 1. That is, the potential difference across the shunt resistor 1 is measured using the four-terminal method.

Therefore, compared to the two-terminal method, where the potential difference between both ends of the shunt resistor 1 is measured by a voltmeter as the potential difference between the first force land 33a and the second force land 33b, this method eliminates the effects of wiring resistance and the like. This allows for more accurate measurement of the potential difference between both ends of the shunt resistor 1 having a low resistance value and consequently, enables more accurate measurement of the resistance value of the shunt resistor 1.

The shunt resistor 1 is formed in the following manner. The resistor body 3 is formed by processing an alloy. By performing metal processing such as bending on a copper plate, a pair of electrode parts 5, including the first electrode part 5a and the second electrode part 5b, is formed. Each of the first electrode part 5a and the second electrode part 5b includes a flat section 7 that is to be mounted on the mounting surface FS, and an inclined section 9.

Next, the resistor body 3 is joined to the pair of electrode parts 5, respectively, such that the resistor body 3 is positioned between the first electrode part 5a and the second electrode part 5b. In this case, by joining the inclined section 9 of the first electrode part 5a and the inclined section 9 of the second electrode part 5b to the resistor body 3, the resistor 3 is positioned at a height differing from the mounting surface. Next, by forming a slit 15 in each of the pair of electrode parts 5, the shunt resistor 1 having the force terminal 11 and the sense terminal 13 is completed.

Since the resistance value of the shunt resistor 1 changes with its temperature, making the temperature coefficient of resistance close to zero is necessary for more accurate measurement of the low resistance value. In this study, the inventors discovered, through various evaluations, that the temperature coefficient of resistance of the shunt resistor 1 can be adjusted by changing the position, length, or width of the slit 15 formed in the electrode part 5 of the shunt resistor 1.

In those evaluations, the position, length, and width of the slit 15 were defined as follows. As shown in FIG. 4, first, on each of the pair of electrode parts 5, a starting point 21c was defined on a non-joined edge 21, which is located on the side not connected to the resistor body 3 and extends in the Y-axis direction (first direction), at a position separated by a predetermined length (first length) from one end 21a of the non-joined edge 21 towards the other end 21b opposite to the end 21a.

The length in the X-axis direction (second direction), which intersects the Y-axis direction, from the starting point 21c towards the side bonded to the resistor body 3, was defined as the length S1 of the slit 15. Furthermore, the length in the Y-axis direction from the starting point 21c towards the other end 21b of the non-bonded edge 21 (third length) was defined as the width S2 of the slit 15. The predetermined length from one end 21a to the starting point 21c on the non-joined edge 21 corresponds to the width W1 of the sense terminal 13.

Below, in each embodiment, the evaluations conducted by the inventors and the results of those evaluations regarding the relationship between the position, length, or width of the slit 15 and the temperature coefficient of resistance will be specifically explained.

### Embodiment 1

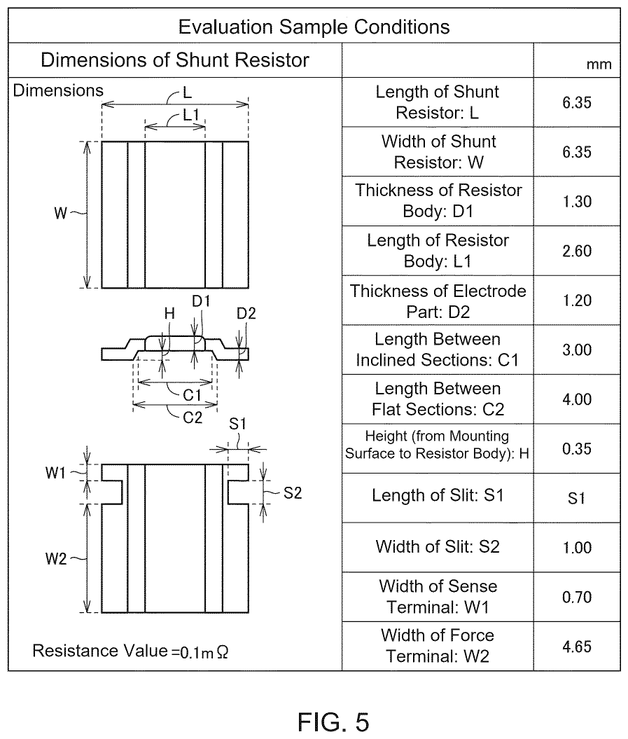

In Embodiment 1, the relationship between the length of the slit and the temperature coefficient of resistance will be explained. As shown in FIG. 5, the following evaluation samples were prepared as evaluation samples for the shunt resistor. The resistance value of the shunt resistor 1 was set to 0.1 mΩ. The length L of the shunt resistor 1 was set to 6.35 mm. The width W of the shunt resistor 1 was set to 6.35 mm. The thickness D1 of the resistor body 3 was set to 1.30 mm.

The length L1 of the resistor body 3 was set to 2.60 mm. The thickness D2 of the electrode part 5 was set to 1.20 mm. The length C1 between the inclined sections 9 was set to 3.00 mm. The length C2 between the flat sections 7 was set to 4.00 mm. The height H from the mounting surface to the resistor body 3 was set to 0.35 mm. The width S2 of the slit 15 was set to 1.00 mm. The width W1 of the sense terminal 13 was set to 0.70 mm. The width W2 of the force terminal 11 was set to 4.65 mm.

As evaluation samples with varying lengths S1 of the slit 15, evaluation samples with five different parameters (S1=0.50 mm, S1=0.60 mm, S1=0.65 mm, S1=0.70 mm, S1=0.80 mm) were prepared. Also, as a reference, an evaluation sample without a slit was prepared as well.

Four different parameters (−65° C., +60° C., +125° C., +175° C.) were identified as the temperature conditions, and a test substrate having a shunt resistor (evaluation sample) mounted thereon was placed in constant temperature baths set to the respective temperatures. Then, electric current was made to flow through the shunt resistors in that state, and the resistance values were measured. The reference resistance value was defined as the resistance value measured with the test substrate placed in a constant temperature bath at the reference temperature (25° C.).

The temperature coefficient of resistance (ppm/° C.) at each temperature is calculated from the resistance value (R) measured at each temperature (T) and the resistance value (Ra) measured at the reference temperature (Ta=25° C.) using the following formula:

Temperature coefficient of resistance=(R−Ra)/Ra÷(T−Ta)×1000000

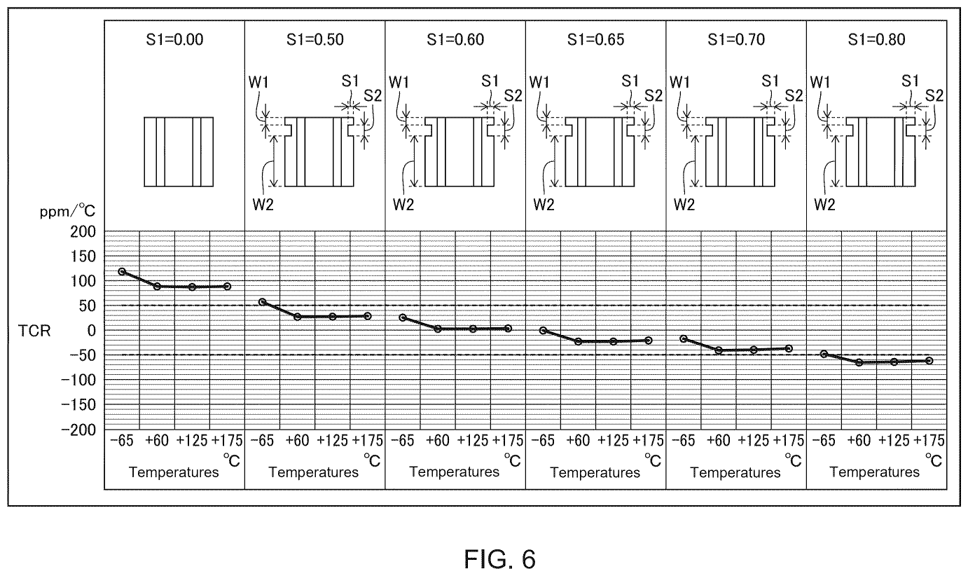

FIG. 6 shows the evaluation results of the relationship between the slit length S1 and the temperature coefficient of resistance. As shown in FIG. 6, it can be seen that as the slit is formed and its length increases, the value of the temperature coefficient of resistance (TCR) at each corresponding temperature decreases, compared to the state where no slit is formed. This evaluation result shows that by setting the slit length S1 to 0.60 mm, the temperature coefficient of resistance can be brought closer to zero with respect to temperature changes.

### Embodiment 2

In Embodiment 2, the relationship between the width of the sense terminal that corresponds to the position of the slit and the temperature coefficient of resistance will be described. In Embodiment 2 and the subsequent embodiments, the temperature coefficient of resistance was calculated through simulation.

Here, the simulation process will be briefly explained. First, a model diagram of a shunt resistor with four terminals was prepared. The resistance value of the shunt resistor 1 was assumed to be 0.1 mΩ. Next, a pattern model of the land corresponding to the shunt resistor was created. Then, based on the shunt resistor model and the land pattern model, the resistance value of the shunt resistor was determined under predetermined temperature conditions. Two temperature conditions were set: −65° C. and +175° C.

Next, using the calculated resistance values, the temperature coefficient of resistance was determined using the calculation formula mentioned above.

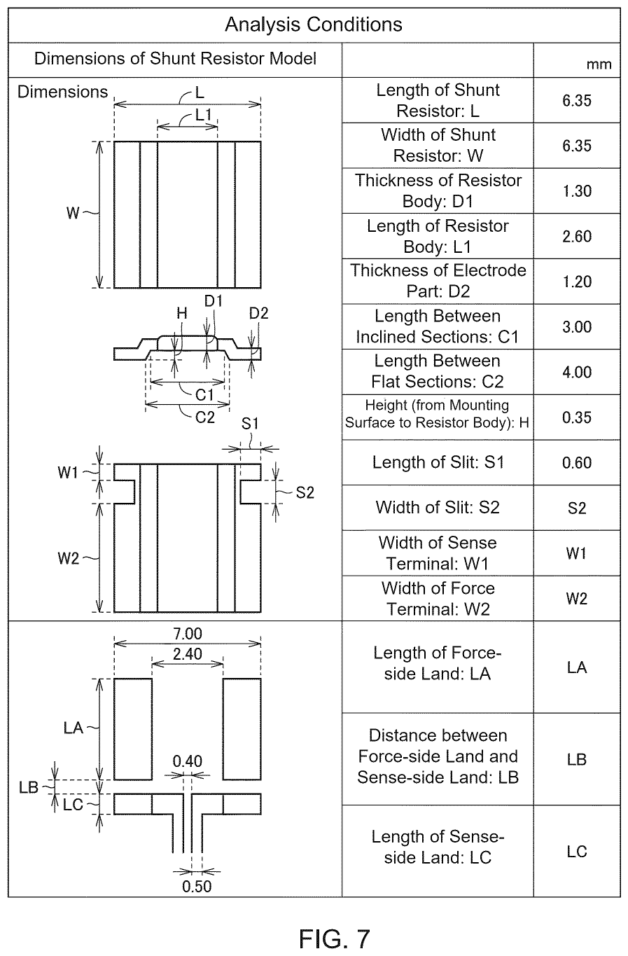

Next, the model of the shunt resistor will be described more specifically. For the shunt resistor mode, each parameter was set as follows. As illustrated in FIG. 7, the length L of the shunt resistor 1 was set to 6.35 mm. The width W of the shunt resistor 1 was set to 6.35 mm. The thickness D1 of the resistor body 3 was set to 1.30 mm. The length L1 of the resistor body 3 was set to 2.60 mm. The thickness D2 of the electrode part 5 was set to 1.20 mm. The length C1 between the inclined sections 9 was set to 3.00 mm. The length C2 between the flat sections 7 was set to 4.00 mm. The height H from the mounting surface to the resistor body 3 was set to 0.35 mm.

The length S1 of the slit 15 was set to 0.60 mm. The width S2 of the slit 15 was set to 1.00 mm. The width W1 of the sense terminal 13 was set to three different values: 0.70 mm, 1.40 mm, and 2.10 mm. In this case, the position (starting point) of the slit 15 is determined by this width W1. The width W2 of the force terminal was set to different values (4.65 mm, 3.95 mm, 3.25 mm) corresponding to the respective values of the width W1 of the sense terminal 13.

Next, the land pattern model will be described more specifically. The length LA of the force-side land was set to different values (5.00 mm, 4.30 mm, 3.60 mm) corresponding to the width W2 of the force terminal. The length LC of the sense-side land was set to different values (1.00 mm, 1.70 mm, 2.40 mm) corresponding to the width W1 of the sense terminal.

For the distance between the lands, the distance on the outer side was set to 7.00 mm, and the distance on the inner side was set to 2.40 mm. The interval LB between the force-side land and the sense-side land was set to 0.70 mm. The width of the sense line was set to 0.50 mm, and the spacing between the respective sense lines was set to 0.40 mm.

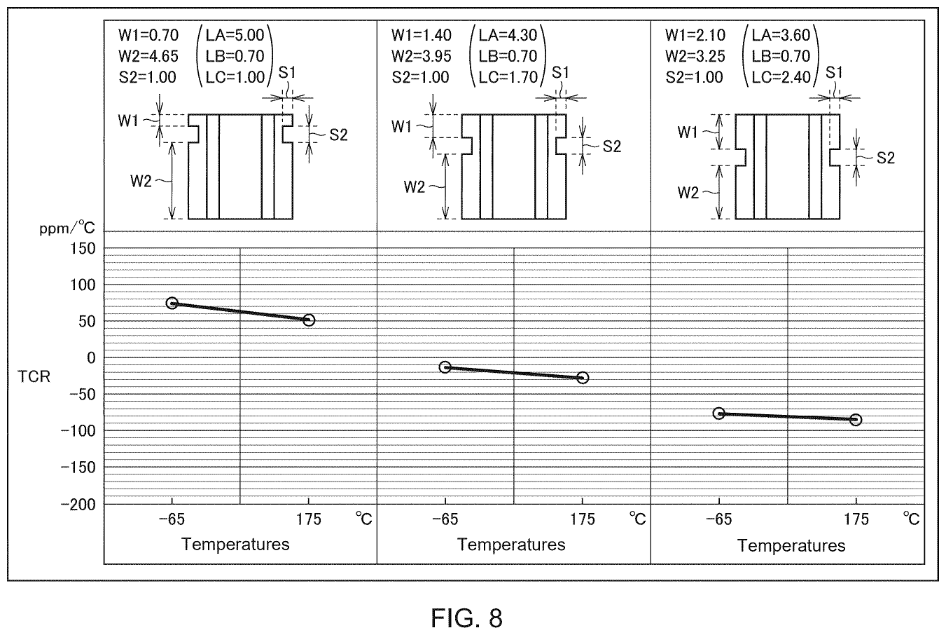

Next, the evaluation results will be explained. FIG. 8 shows the simulation results evaluating the relationship between the width W1 of the sense terminal 13 and the temperature coefficient of resistance. As shown in FIG. 8, it can be seen that as the width W1 of the sense terminal 13 increases, the value of the temperature coefficient of resistance (TCR) at each corresponding temperature decreases. This evaluation result shows that by setting the width W1 of the sense terminal 13 to 1.40 mm, the temperature coefficient of resistance can be brought closer to zero with respect to temperature changes.

### Embodiment 3

In Embodiment 3, the relationship between the width of the slit and the temperature coefficient of resistance will be explained. For the shunt resistor mode, each parameter was set as follows. The width S2 of the slit 15 was set to three different values: 1.00 mm, 1.50 mm, and 2.00 mm. Also, as the position (starting point) of the slit 15, the width W1 of the sense terminal 13 was set to 0.70 mm. Other values were the same as those shown in FIG. 7.

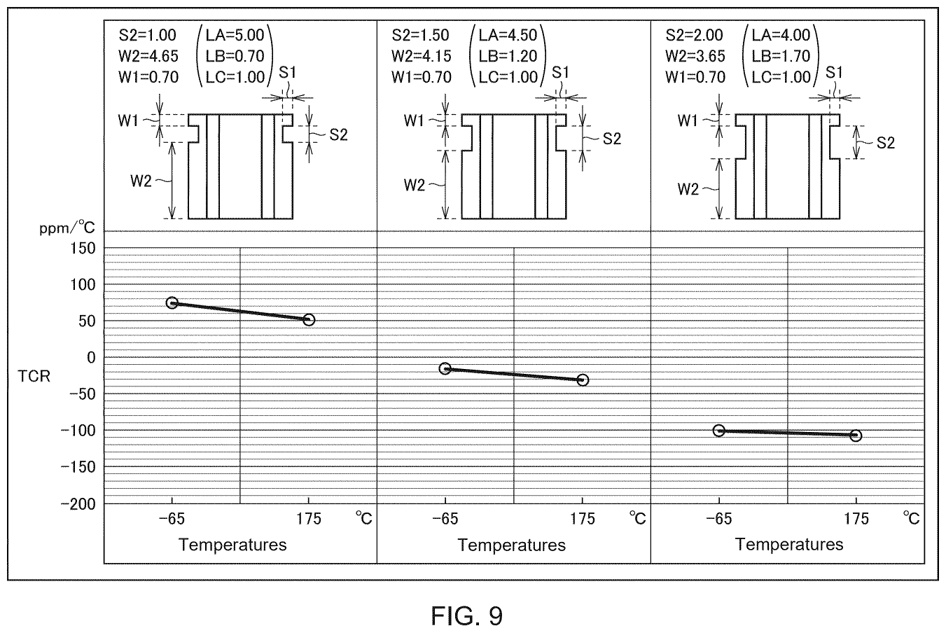

FIG. 9 shows the simulation results evaluating the relationship between the width S2 of the slit 15 and the temperature coefficient of resistance. As shown in FIG. 9, it can be seen that as the width S2 of the slit 15 increases, the value of the temperature coefficient of resistance (TCR) at each corresponding temperature decreases. This evaluation result shows that by setting the width S2 of the slit 15 to 1.50 mm, the temperature coefficient of resistance can be brought closer to zero with respect to temperature changes.

### Embodiment 4

In Embodiment 4, the relationship between the width of the sense terminal and the temperature coefficient of resistance in the shunt resistor in which slits are arranged such that they are symmetric with respect to a point will be explained.

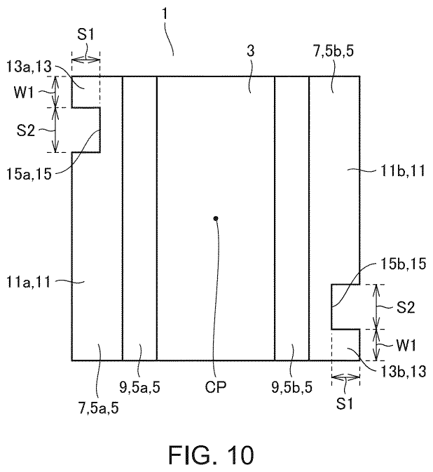

As shown in FIG. 10. a model of the shunt resistor 1 was set in which a first slit 15a and a second slit 15b are arranged symmetrically with respect to the center point CP of the shunt resistor 1 in a plan view seeing the shunt resistor 1 from above. The center point CP was defined as the intersection of the diagonals connecting the vertices of the shunt resistor 1 in a plan view.

The width W1 of the sense terminal 13 was set to three different values: 0.70 mm, 1.40 mm, and 2.10 mm. The width W1 of the sense terminal 13 corresponds to the position of the slit 15 (starting point). Other values were the same as those shown in FIG. 7.

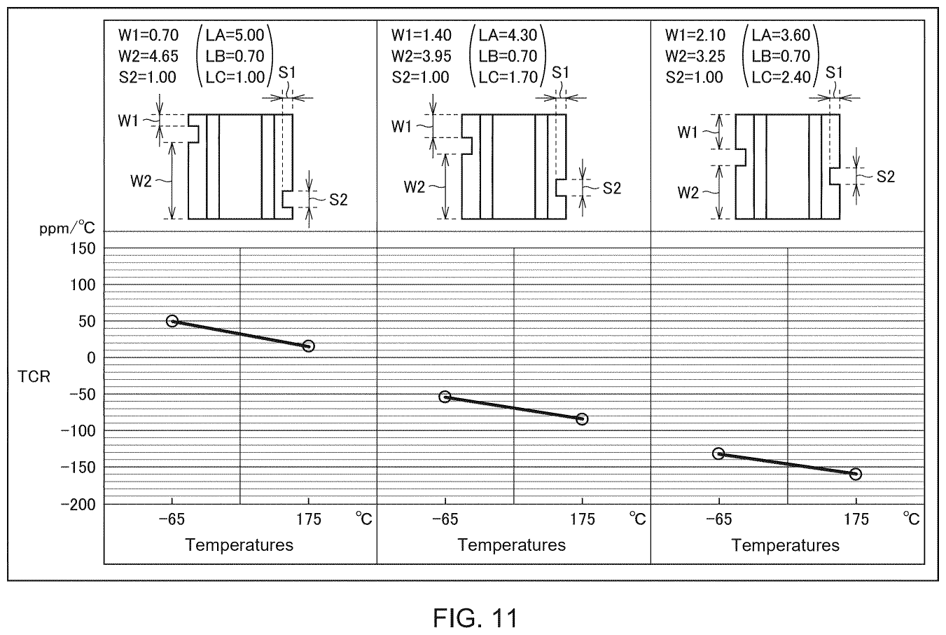

FIG. 11 shows the simulation results evaluating the relationship between the width W1 of the sense terminal 13 and the temperature coefficient of resistance. As shown in FIG. 11, it can be seen that as the width W1 of the sense terminal 13 increases, the value of the temperature coefficient of resistance (TCR) at each corresponding temperature decreases. This evaluation result shows that by setting the width W1 of the sense terminal 13 to 0.70 mm, the temperature coefficient of resistance can be brought closer to zero with respect to temperature changes.

### Embodiment 5

In Embodiment 5, the relationship between the width of the slit and the temperature coefficient of resistance in the shunt resistor in which slits are arranged such that they are symmetric with respect to a point will be explained.

The width S2 of the slit 15 was set to three different values: 1.00 mm, 1.50 mm, and 2.00 mm. Also, the width W1 of the sense terminal 13, which corresponds to the position (starting point) of the slit 15, was set to 0.70 mm. Other values were the same as those shown in FIG. 7.

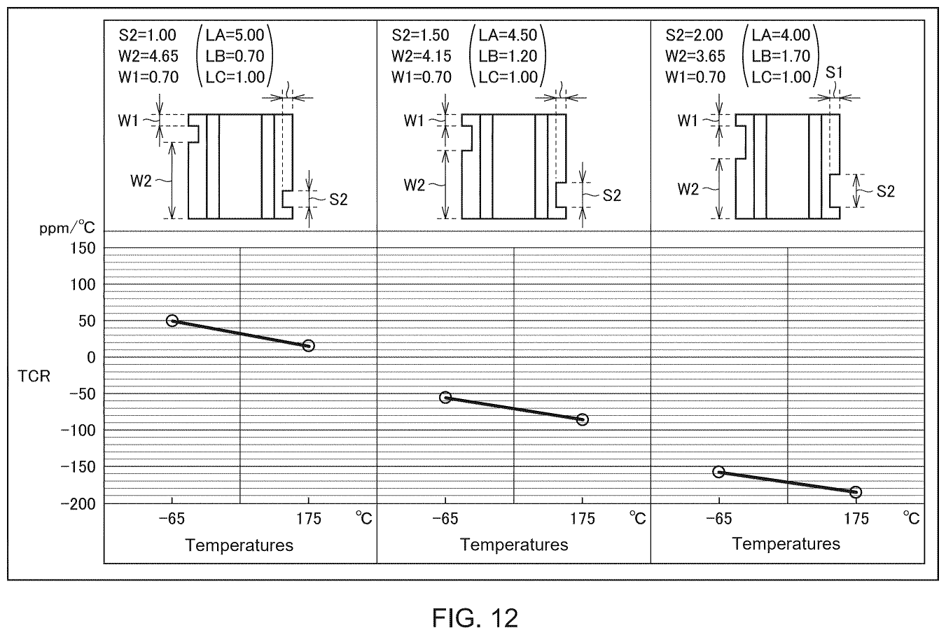

FIG. 12 shows the simulation results evaluating the relationship between the width S2 of the slit 15 and the temperature coefficient of resistance. As shown in FIG. 12, it can be seen that as the width S2 of the slit 15 increases, the value of the temperature coefficient of resistance (TCR) at each corresponding temperature decreases. This evaluation result shows that by setting the width S2 of the slit 15 to 1.00 mm, the temperature coefficient of resistance can be brought closer to zero with respect to temperature changes.

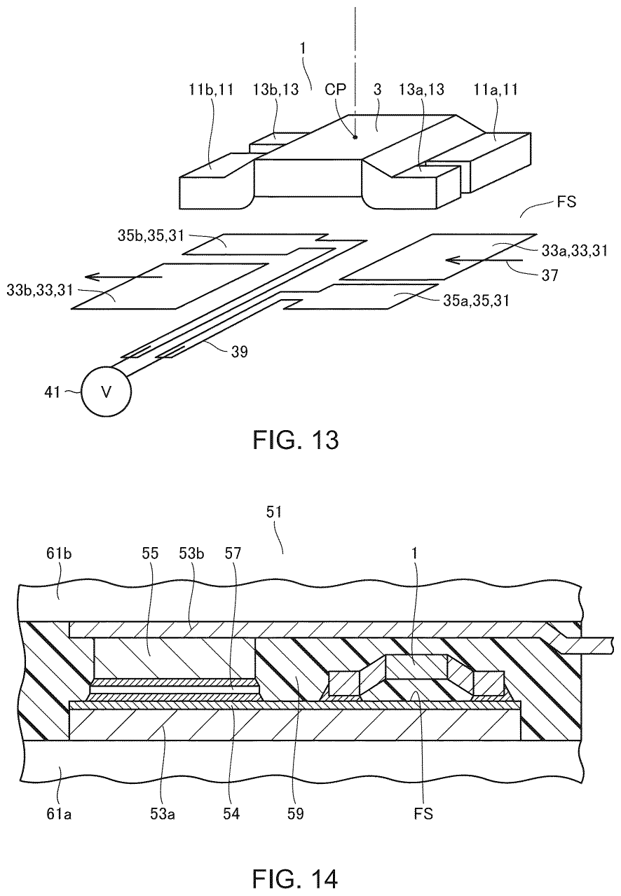

The shunt resistor 1 configured such that the slits are arranged symmetrically with respect to a point offers the following advantages when mounted on a circuit board. As shown in FIG. 13, even if the orientation of the shunt resistor 1 is rotated by 180 degrees around the center point CP, the force terminal 11 can still make contact with the force land 33, and the sense terminal 13 can still make contact with the sense land 35.

By considering both the temperature coefficient of resistance of the shunt resistor 1 measured using the evaluation samples (Embodiment 1) and the temperature coefficient of resistance of the shunt resistor 1 calculated through simulation (Embodiments 2-5), the following insights can be obtained regarding the temperature coefficient of resistance of the shunt resistor 1.

That is, it is preferable that at least one of the starting point 21c of the slit 15 (first length), the length S1 of the slit 15 (second length), and the width S2 of the slit (third length) is set such that the temperature coefficient of resistance of the shunt resistor 1 is between −50 ppm/° C. and +50 ppm/° C. at temperatures between −65° C. and +175° C. This makes it possible to suppress variations in the resistance value of the shunt resistor 1 due to temperature changes.

On the other hand, if the temperature coefficient of resistance of the shunt resistor 1 is lower than −50 ppm/° C. or higher than +50 ppm/° C. at −65° C. and +175° C., it becomes difficult to suppress variations in the resistance value of the shunt resistor 1 due to temperature changes.

### Application Example of Shunt Resistor

As an example of an electronic device to which the shunt resistor 1 according to each embodiment is applied, a power module mounted in an inverter will be described.

As shown in FIG. 14, in a power module 51, a power semiconductor element 57 and the shunt resistor 1 are mounted on a conductor plate 54 located on a first plate 53a. A second plate 53b is positioned on the power semiconductor element 57 with a spacer 55 interposed therebetween. A first cooling tube 61a is positioned to be in contact with the first plate 53a. A second cooling tube 61b is positioned to be in contact with the second plate 53b.

The power semiconductor element 57 and the shunt resistor 1 are sealed by a sealing material 59. The sealing material 59 is filled into the space between the first cooling tube 61a and the second cooling tube 61b, including the area sandwiched between the first plate 53a and the second plate 53b.

In the power module 51, a large current flows through the power semiconductor element 57, causing it to generate heat and increasing the temperature of the power module 51. The power module 51 is cooled by having cooling water or the like flow through the first cooling tube 61a and the second cooling tube 61b, respectively

In the shunt resistor 1 according to each embodiment, the resistor body 3, which is positioned at a height differing from the mounting surface FS on which the flat sections 7 (a pair of electrode parts 5) is mounted, is joined to the inclined sections 9 (a pair of electrode parts 5). Therefore, compared to a structure in which a resistor is joined to an upright electrode part, the height of the resistor body 3 from the mounting surface FS can be kept low, allowing for a reduction in the overall height of the shunt resistor 1.

By keeping the height of the resistor body 3 low, the thickness of the spacer 55 can also be reduced, allowing for a thinner power module 51. By reducing the thickness of the power module 51 positioned between the first cooling tube 61a and the second cooling tube 61b, the power module 51 can be cooled efficiently, and the temperature rise of the power module 51 can be effectively suppressed. As a result, it is possible to help suppress variations in the resistance value of the shunt resistor 1 due to temperature changes.

In the shunt resistor 1 according to each embodiment, the slit 15 is formed from the non-joined side (non-joined edge 21) toward the resistor body 3 such that the resistor body 3 and the slit 15 are not in contact with each other (see FIG. 4). That is, the slit 15 is formed such that a copper plate of the electrode part 5 remains between the slit 15 and the resistor body 3.

That is, as compared with a shunt resistor of the same size in which the slit 15 is formed to reach the resistor body 3 and there is no copper plate between the slit 15 and the resistor body 3, the thermal capacitance of the electrode part 5 can be increased. As a result, the shunt resistor 1 can ensure a higher rated power.

The dimensions and other numerical values shown for the shunt resistor 1 in each embodiment are merely examples and are not limiting. Appropriate values will be set depending on the application of the shunt resistor 1.

The shunt resistors described in the respective embodiments above may be combined in various manners.

The embodiments disclosed herein are illustrative and not limiting. The present invention is not limited to the scope described above, but is defined by the claims, and it is intended that all modifications within the meaning and scope equivalent to the claims are included.

The present disclosure includes the following embodiments.

### Supplementary Note 1

A shunt resistor, including:
a pair of electrode parts including a first electrode part and a second electrode part; and
a resistor body arranged between the first electrode part and the second electrode part and joined to the first electrode part and the second electrode part, respectively,
wherein the resistor body is positioned at a height differing from that of a mounting surface on which the pair of electrode parts is to be mounted, and
wherein each of the pair of electrode parts has:
a force terminal to which electric current is to be applied;
a sense terminal from which a voltage is to be measured;
a slit formed between the force terminal and the sense terminal, cut from a non-joined side connected to the resistor body toward a joined side connected to the resistor body;
a flat section that is to be mounted on the mounting surface; and
an inclined section bonded to the resistor body such that it inclines from the flat section to the resistor body.

### Supplementary Note 2

The shunt resistor according to Supplementary Note 1, wherein the slit is formed at a distance from the resistor body, extending from the non-joined side towards the joined side.

### Supplementary Note 3

The shunt resistor according to Supplementary Note 2, wherein the slit is formed in the flat section.

### Supplementary Note 4

The shunt resistor according to any one of Supplementary Notes 1 to 3, wherein each of the pair of electrode parts has a non-joined edge that is positioned at the non-joined side and extends in a first direction,
wherein the slit is formed such that, when a point on the non-joined edge at a first length from one end of the non-joined edge toward the other end, which is the opposite end of the one end, is defined as a starting point, the slit has a second length as the length of the silt extending from the starting point toward the joined side in a second direction that intersects with the first direction, and a third length as the width of the slit extending from the starting point toward the other end of the non-joined edge, and
wherein at least one of the first length, the second length, and the third length is set such that the temperature coefficient of resistance, which indicates the rate of change in resistance value with respect to temperature change of the shunt resistor, is between −50 ppm/° C. and +50 ppm/° C. at temperatures between −65° C. and +175° C.

To achieve the temperature coefficient of resistance of the shunt resistor 1 of between-50 ppm/° C. and +50 ppm/° C. at temperatures between −65° C. and +175° C., the first length can be between 0.70 mm and 1.40 mm, the second length can be between 0.50 mm and 0.80 mm, and the third length can be between 1.00 mm and 1.50 mm, as shown in FIGS. 6, 8 and 9, for example.

### Supplementary Note 5

The shunt resistor according to any one of Supplementary Notes 1 to 4, wherein the slit formed in each of the pair of electrode parts is formed such that, in a plan view seeing the pair of electrode parts mounted on the mounting surface from above, those slits are symmetrical with respect to a bisecting line CL that divides the shunt resistor into two equal halves.

### Supplementary Note 6

The shunt resistor according to any one of Supplementary Notes 1 to 4, wherein the slit formed in each of the pair of electrode parts is formed such that, in a plan view seeing the pair of electrode parts mounted on the mounting surface from above, those slits are symmetrical with respect to a center point of the shunt resistor.

### Supplementary Note 7

A manufacturing method of a shunt resistor having a slit, including:
forming a resistor body by processing an alloy;
forming a pair of electrode parts including a first electrode part and a second electrode part to be mounted on a mounting surface by performing metal processing on a metal plate such as bending;
joining the resistor body to each of the first electrode part and the second electrode part such that the resistor body is positioned at a height differing from that of the mounting surface between the first electrode part and the second electrode part; and
forming a sense terminal and a force terminal by forming the slit in each of the pair of electrode parts, cut from a non-joined side not connected to the resistor body toward a joined side connected to the resistor body,
wherein, in the step of forming the sense terminal and the force terminal, at least one of the position of the slit, the length of the slit, and the width of the slit is adjusted such that the value of the temperature coefficient of resistance, which indicates the rate of change in resistance value with respect to temperature change of the shunt resistor, is brought closer to 0 ppm/° C.

### Supplementary Note 8

The manufacturing method of a shunt resistor according to Supplementary Note 7, wherein the step of forming the pair of electrode parts includes forming a flat section to be mounted on the mounting surface and an inclined section that inclines from the flat section toward the resistor body that is to be positioned at a height differing from the mounting surface.

### Supplementary Note 9

The manufacturing method of a shunt resistor according to Supplementary Note 7 or 8, wherein the step of forming the sense terminal and the force terminal includes forming the slit at a distance from the resistor body to extend from the non-joined side towards the joined side.

### Supplementary Note 10

The manufacturing method of a shunt resistor according to any one of Supplementary Notes 7 to 9, wherein, in the step of forming the sense terminal and the force terminal, if a point on the non-joined edge at a first length from one end of the non-joined edge extending toward the other end, which is the opposite end of the one end, is defined as a starting point in each of the pair of electrode parts, the slit is formed such that the slit has a second length as the length of the silt extending from the starting point toward the joined side in a second direction that intersects with the first direction, and a third length as the width of the slit extending from the starting point toward the other end of the non-joined edge,
wherein at least one of the first length, the second length, and the third length is set such that the temperature coefficient of resistance is brought closer to 0 ppm/° C.

In embodiments, the value of the temperature coefficient of resistance can be brought to between 10 ppm/° C. and −10 ppm/° C., as shown in FIG. 6, for example. To achieve the temperature coefficient of resistance between 10 ppm/° C. and −10 ppm/° C., the second length of the slit can be between 0.60 mm and 0.65 mm.

### Supplementary Note 11

The manufacturing method of a shunt resistor according to any one of Supplementary Notes 7 to 10, wherein the step of forming the sense terminal and the force terminal includes forming the slit in each of the pair of electrode parts such that, in a plan view seeing the pair of electrode parts mounted on the mounting surface from above, those slits are symmetrical with respect to a bisecting line CL that divides the shunt resistor into two equal halves.

### Supplementary Note 12

The manufacturing method of a shunt resistor according to any one of Supplementary Notes 7 to 10, wherein the step of forming the sense terminal and the force terminal includes forming the slit in each of the pair of electrode parts such that, in a plan view seeing the pair of electrode parts mounted on the mounting surface from above, those slits are symmetrical with respect to a center point of the shunt resistor.

### INDUSTRIAL APPLICABILITY

The present disclosure is effectively applied to a shunt resistor having four terminals.

What is claimed is:

1. A shunt resistor, comprising:
a pair of electrode parts including a first electrode part and a second electrode part; and
a resistor body arranged between the first electrode part and the second electrode part and joined to the first electrode part and the second electrode part, respectively,
wherein the resistor body is positioned at a height differing from that of a mounting surface on which the pair of electrode parts is to be mounted, and
wherein each of the pair of electrode parts has:
a force terminal to which electric current is to be applied;
a sense terminal from which a voltage is to be measured;
a slit formed between the force terminal and the sense terminal, cut from a non-joined side not connected to the resistor body toward a joined side connected to the resistor body;
a flat section that is to be mounted on the mounting surface; and
an inclined section joined to the resistor body such that the inclined section inclines from the flat section to the resistor body.

2. The shunt resistor according to claim 1, wherein the slit is formed at a distance from the resistor body.

3. The shunt resistor according to claim 2, wherein the slit is formed in the flat section.

4. The shunt resistor according to claim 1, wherein each of the pair of electrode parts has a non-joined edge that is positioned at the non-joined side and extends in a first direction,
wherein the slit is formed such that, when a point on the non-joined edge at a first length from one end of the non-joined edge toward another end that is an opposite end of the one end is defined as a starting point, the slit has a second length extending from the starting point toward the joined side in a second direction that intersects with the first direction, and a third length as a width of the slit extending from the starting point toward the other end of the non-joined edge, and
wherein at least one of the first length, the second length, and the third length is set such that a temperature coefficient of resistance that indicates a rate of change in resistance value with respect to temperature change of the shunt resistor is between −50 ppm/° C. and +50 ppm/° C. at temperatures between −65° C. and +175° C.

5. The shunt resistor according to claim 1, wherein the slit is formed such that, in a plan view of the pair of electrode parts mounted on the mounting surface, the slit of one of the pair of electrode parts and the slit of another one of the pair of electrode parts are symmetrical with respect to a bisecting line that divides the shunt resistor into two equal halves.

6. The shunt resistor according to claim 1, wherein the slit is formed such that, in a plan view of the pair of electrode parts mounted on the mounting surface, the slit of one of the pair of electrode parts and the slit of another one of the pair of electrode parts are symmetrical with respect to a center point of the shunt resistor.

7. A manufacturing method of a shunt resistor having a slit, comprising:
forming a resistor body by processing an alloy;
forming a pair of electrode parts including a first electrode part and a second electrode part to be mounted on a mounting surface by performing metal processing on a metal plate, the metal processing including bending;
joining the resistor body to each of the first electrode part and the second electrode part such that the resistor body is positioned at a height differing from a height of the mounting surface between the first electrode part and the second electrode part; and
forming a sense terminal and a force terminal by forming the slit in each of the pair of electrode parts, the slit being cut from a non-joined side not connected to the resistor body toward a joined side connected to the resistor body,
wherein, in the step of forming the sense terminal and the force terminal, at least one of a position of the slit, length of the slit, and width of the slit is adjusted such that a value of a temperature coefficient of resistance that indicates a rate of change in resistance value with respect to temperature change of the shunt resistor is brought to between 10 ppm/° C. and −10 ppm/° C.

8. The manufacturing method of a shunt resistor according to claim 7, wherein the step of forming the pair of electrode parts includes forming a flat section to be mounted on the mounting surface and an inclined section that inclines from the flat section toward the resistor body, the flat section being arranged at a height differing from the height of the mounting surface.

9. The manufacturing method of a shunt resistor according to claim 7, wherein the step of forming the sense terminal and the force terminal includes forming the slit at a distance from the resistor body.

10. The manufacturing method of a shunt resistor according to claim 7, wherein, in the step of forming the sense terminal and the force terminal, if a point on the non-joined side at a first length extending from one end of the non-joined side toward another end that is an opposite end of the one end is defined as a starting point in each of the pair of electrode parts, the slit is formed such that the slit has a second length as a length of the slit extending from the starting point toward the joined side in a second direction that intersects with the first direction, and a third length as a width of the slit extending from the starting point toward the other end of the non-joined edge, and
wherein at least one of the first length, the second length, and the third length is set such that the temperature coefficient of resistance is brought to between 10 ppm/° C. and −10 ppm/° C.

11. The manufacturing method of a shunt resistor according to claim 7, wherein the step of forming the sense terminal and the force terminal includes forming the slit in each of the pair of electrode parts such that, in a plan view of the pair of electrode parts mounted on the mounting surface, the slit of one of the pair of electrode parts and the slit of another one of the pair of electrode parts are symmetrical with respect to a bisecting line that divides the shunt resistor into two equal halves.

12. The manufacturing method of a shunt resistor according to claim 7, wherein the step of forming the sense terminal and the force terminal includes forming the slit in each of the pair of electrode parts such that, in a plan view of the pair of electrode parts mounted on the mounting surface, the slit of one of the pair of electrode parts and the slit of another one of the pair of electrode parts are symmetrical with respect to a center point of the shunt resistor.

13. The shunt resistor according to claim 4, wherein the first length is between 0.70 mm and 1.40 mm, the second length is between 0.50 mm and 0.80 mm, and the third length is between 1.00 mm and 1.50 mm.

14. The manufacturing method of a shunt resistor according to claim 10, wherein the second length of the slit is between 0.60 mm and 0.65 mm.
